(19) United States
(12) Patent Application Publication
(10) Pub. No.: US 2009/0243277 A1
(43) Pub. Date: Oct. 1, 2009

(54) Stamp, envelope and meter in sticking, printing and cancelling

(76) Inventor: Zhong Ren Liu, Flower Mount, TX (US)

Correspondence Address: RUDOLPH J. BUCHEL JR., LAW OFFICE OF, P. O. BOX 702526, DALLAS, TX, 75370-2526, US

(21) Appl. No.: 12/079,394

(22) Filed: Mar. 26, 2008

(51) Int. Cl. G09F 3/00

(52) U.S. Cl. 283/71; 283/72

(57) ABSTRACT

The present invention is directed to a system for thermally cancelling postage and a thermally cancellable picture postage stamp for use therein. A picture postage stamp is disclosed wherein the design and postage information are affixed on thermally reactive paper. Alternatively, the indicia may be comprised of thermally reactive inks or dyes. Cancelling a thermally cancellable picture postage stamp is accomplished with a heat source such as a cancellation write head. Hidden text of code can be embedded in the thermal paper and the cancellation mark can be any indicia or information that can be generated by a thermal print head. Cancelling the thermally cancellable picture postage stamp may also be accomplished manually with a pointed instrument or any semi hard edge such as a pen cap, ring or fingernail. Cancellation of the present thermally cancellable picture postage stamp can be further verified by placing the stamp on a presently described envelope or mailer having a thermally reactive area for receiving postage and cancellations. Using an envelope with a thermally reactive area allows for thermal cancellations that extend beyond the boundary of the thermally cancellable picture postage stamp, thereby effectively matching the thermal cancellation of the stamp to the cancellation on the envelope. The present thermally cancellable picture postage stamps may be manually applied using a cancellation gun that simultaneously applies postage and cancels same on a mailer.

### BACKGROUND OF THE INVENTION

The present invention relates generally to postage cancellation. More particularly, the present invention relates to a system for thermally cancelling postage and a thermally cancellable picture postage stamp for use in the system.

Picture postage stamps are the predominate form of pre-paying for postal services in the United States and in most other countries. Most picture stamps consist of a small paper rectangle or square paper substrate with an easily identifiable indicia or image and a postage amount. They are affixed to an envelope or other mailer by a gum-free pressure sensitive adhesive or a water activated glue on the rear surface of the stamp. Because picture stamps can be removed from a posted envelope with relatively little effort and then reused, the U.S. Postal Service has mandated that every picture stamp be cancelled during sorting at a postal processing and distribution center. Since the Civil War the U.S. Postal Service has waged an ongoing battle against postage stamp reuse. Currently, estimates place picture stamps as accounting for 30% of revenue for the almost 47 billion dollar operating budget of the U.S. Postal Service.

Mail received at a postal processing and distribution center is sorted by type; the processing of standard sized envelopes and cards is highly automated. Before entering the automated portion, route carriers separate metered mail into separate bins from stamped mail, which are designated for cancelling and postmarking. After initial culling of bundles and packages, the remaining mail enters the Advanced Facer-Canceler System (AFCS/ISS) for cancelling. The cancellation section is the slowest section in the mailing process. Pieces that do not conform to physical dimensions for processing in the AFCS/ISS (i.e. large envelopes or overstuffed standard envelopes) are automatically diverted from the stream and are manually cancelled. The AFCS/ISS is an extremely cumbersome machine requiring up to twenty postal workers to operate, and that, due to its mechanically letter facing, is specially fitted with exposure protection and a vacuum system for chemical and biological tainted mail threats, such as recent Anthrax laces postage. Likewise, metered mail bins found to contain stamped mail are rerouted for manual cancellation. The AFCS/ISS is a remarkable device that can locate the position of postage on an envelope, and reorient the envelope to the proper orientation (face the envelope) before cancelling the stamp. Pieces that do not receive a cancellation and those that are mis-cancelled are segregated for manual cancellation.

Manual cancellation typically involves a postal worker checking each piece for postage and then manually, or hand-cancelling the stamp with a pen or marker (hence the term “pen cancellation”). In the past, pen cancelling a stamp involved making a specified mark, such as a set of initials, an “X” or “Z”, or a checkered pattern, which involved making several pen strokes. Postal workers routinely pen cancel two to five thousand pieces at a time. With the current volume of hand cancellations, most workers mark a nondescript cancellation line somewhere across the stamp. Pen cancelling is an arduous process that typically results in an additional three to seven days to the delivery time. Even including manual cancelling, about 5% of the stamps processed are not cancelled before being sent to the addressee.

Increasing, stamp reuse includes stamps that have been cancelled. An illegal cottage mail fraud industry has evolved for the purpose of thwarting cancelling efforts. While the details of these efforts need not be disclosed herein, several reliable methods exist for immunizing postal stamps from the cancelling dye or washing the dye from a stamp. Other techniques have evolved for lifting stamps from envelopes without damaging the stamp.

### BRIEF SUMMARY OF THE INVENTION

The present invention is directed to a system for thermally cancelling postage and a thermally cancellable picture postage stamp for use therein. A picture postage stamp is disclosed wherein the design and postage information are affixed on thermally reactive paper. Alternatively, the indicia may be comprised of thermally reactive inks or dyes. Cancelling a thermally cancellable picture postage stamp is accomplished with a heat source such as a cancellation write head. Hidden text of code can be embedded in the thermal paper and the cancellation mark can be any indicia or information that can be generated by a thermal print head. Cancelling the thermally cancellable picture postage stamp may also be accomplished manually with a pointed instrument or any semi hard edge such as a pen cap, ring or fingernail. Cancellation of the present thermally cancellable picture postage stamp can be further verified by placing the stamp on a presently described envelope or mailer having a thermally reactive area for receiving postage and cancellations. Using an envelope with a thermally reactive area allows for thermal cancellations that extend beyond the boundary of the thermally cancellable picture postage stamp, thereby effectively matching the thermal cancellation of the stamp to the cancellation on the envelope. The present thermally cancellable picture postage stamps may be manually applied using a cancellation gun that simultaneously applies postage and cancels same on a mailer.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1A shows a thermally cancellable stamp with indicia and postage in accordance with one exemplary embodiment of the present invention;

FIG. 1B shows a thermally cancellable stamp after thermal cancelling in accordance with one exemplary embodiment of the present invention;

FIG. 1C shows a thermally cancellable stamp after thermal cancelling in accordance with another exemplary embodiment of the present invention;

FIG. 1D shows a thermally cancellable stamp after manual cancelling in accordance with one exemplary embodiment of the present invention;

FIG. 2A is thermal paper stamp stock for use in self-posting stamps in accordance with one exemplary embodiment of the present invention;

FIG. 2B shows thermal paper stamp stock thermally cancellable stamp after thermal cancelling in accordance with one exemplary embodiment of the present invention;

FIG. 3 shows a thermally cancellable stamp after thermal cancelling and postmarking in accordance with another exemplary embodiment of the present invention;

FIG. 4 shows thermal paper stamp stock with a sabot origination code in accordance with one exemplary embodiment of the present invention;

FIG. 5 shows a thermal paper picture postage stamp with a sabot origination code after thermal cancellation and postmarking in accordance with an exemplary embodiment of the present invention;

FIG. 6A shows a typical number 10 envelope (business letter) with a thermally receptive treatment in the area for receiving postage and cancellations in accordance with one exemplary embodiment of the present invention;

FIG. 6B shows a typical business class flat or packet with a thermally receptive treatment in the area for receiving postage in accordance with one exemplary embodiment of the present invention;

FIG. 7A is a top view of a thermal cancellation writer in accordance with one exemplary embodiment of the present invention;

FIG. 7B is a side view of a thermal cancellation writer in accordance with one exemplary embodiment of the present invention;

FIG. 8 shows a thermally receptive number 10 envelope posted with a thermally cancellable stamp after being cancelled with the present thermal cancellation writer in accordance with an exemplary embodiment of the present invention;

FIG. 9A is a cross-sectional diagram of a manual self-cancelling postage stamp ‘gun’ for simultaneously posting and cancelling a picture postage stamp in accordance with an exemplary embodiment of the present invention;

FIG. 9B is a diagram of a cancellation pen for cancelling a thermally cancellable stamp in accordance with an exemplary embodiment of the present invention;

FIG. 10 shows a thermally receptive number 10 envelope posted with a thermally cancellable stamp after being cancelled with the present self-cancelling postage stamp gun in accordance with an exemplary embodiment of the present invention;

FIG. 11A is a cross-sectional diagram of a thermal self-cancelling postage stamp gun for simultaneously posting and cancelling a picture postage stamp in accordance with an exemplary embodiment of the present invention;

FIG. 11B is a diagram of a thermal cancellation head for thermally cancelling a thermally cancellable stamp in accordance with an exemplary embodiment of the present invention; and

FIG. 12 shows a thermally receptive number 10 envelope posted with a thermally cancellable stamp after being cancelled with the present thermal self-cancelling postage stamp gun in accordance with an exemplary embodiment of the present invention.

Other features of the present invention will be apparent from the accompanying drawings and from the following detailed description.

### DETAILED DESCRIPTION OF THE INVENTION

Element Reference Number Designations

| | |
|---|---|
| 100: | Thermally cancellable picture postage |
| | stamp |
| 102: | Thermal cancellation marks |
| 104: | Thermally cancelled face amount |
| 106: | Thermally cancelled white space |
| 108: | Manual cancellation mark |
| 200: | Thermal substrate paper for postage |
| 202: | Machine cancelled thermal postage |
| | paper |
| 300: | Thermally cancellable picture postage |
| | stamp |
| 302: | Date and postal code cancellation |
| 400: | Thermal substrate paper for postage |
| 402: | Sabot information embedded in thermal |
| | substrate paper for postage |
| 500: | Thermally cancellable stamp with |
| | embedded sabot information |
| 502: | Date and the postal code cancellation |
| | across a thermally cancellable stamp |
| | embedded sabot information |
| 600: | No. 10 envelope with thermally sensitive |
| | cancellation area |
| 602: | Thermally sensitive cancellation area |
| 610: | Mailer with thermally sensitive |
| | cancellation area |
| 612: | Thermally sensitive cancellation area |
| 700: | Thermal cancellation writer |
| 702: | Track |
| 712: | Rollers |
| 720: | Thermal write head |
| 722: | linear strips of heating resistors |
| 724: | Activation zones |
| 730: | Optical sensors |
| 740: | Envelope |
| 742: | Rollers |
| 750: | Thermal write head |
| 751: | linear strips of heating resistors |
| 752: | Forward facing upper corner |
| 754: | Forward facing lower corner |
| 756: | Rearward facing upper corner |
| 758: | Rearward facing lower corner |
| 760: | Optical sensors |
| 800: | Envelope |
| 802: | Thermally cancellable picture postage |
| | stamp |
| 804: | Thermal cancellation mark |
| 806: | Thermally sensitive cancellation area |
| 852: | Forward facing upper corner |
| 854: | Forward facing lower corner |
| 856: | Rearward facing upper corner |
| 858: | Rearward facing lower corner |
| 900: | Manual self-cancelling postage stamp |
| | gun |
| 902: | Thermally cancellable picture postage |
| | stamp |
| 904: | Paper backing |
| 906: | Roll of thermally cancellable stamp on |
| | paper backing |
| 910: | Drive gear |
| 912: | Advance lever |
| 914: | Level stroke adjustment |
| 950: | Cancellation marker |
| 952: | Marker points |
| 954: | Marker covers/cancellation tips |
| 954: | Marker body/reservoir |
| 1000: | Envelope |
| 1002: | Thermally cancellable picture postage |
| | stamp |
| 1004: | Manual cancellation mark |
| 1006: | Score lines |
| 1052: | Thermally receptive cancellation area |
| 1100: | Thermal self-cancelling postage stamp |
| | gun stamp gun |
| 1102: | Thermally cancellable picture postage |
| | stamp |
| 1104: | Paper backing |
| 1106: | Roll of thermally cancellable stamp on |
| | paper backing |
| 1112: | Advancing lever |
| 1114: | Lever stroke adjustment |
| 1150: | Thermal write head |
| 1152: | Thermal write elements |
| 1154: | Date window |
| 1155: | Keypad |
| 1156: | Date adjustment knob |
| 1157: | Screen |
| 1158: | Thermal write head body |
| 1160: | Actuator switch |
| 1200: | Envelope |
| 1202: | Thermally cancellable picture postage |
| | stamp |
| 1204: | Thermal cancellation mark |
| 1206: | Score lines |
| 1206: | Score lines |

Stamp reuse by postal patrons decreases the revenue that a postal service obtains for its services resulting in increasing postage costs for the remaining postal patrons that do not reuse stamps. The primary objective for a postal service is to cancel every picture stamp that is processed and delivered, so that no stamp can be reused. At present, the U.S. Postal Service is less than successful in meeting that objective. Many stamps reach their destination without being cancelled. Furthermore, of the uncancelled stamped mail that is detected in the postal center, many of those letters languish for days awaiting manual cancellation. Furthermore, committed stamped reusers understand not only how to lift uncancelled stamps from envelopes, flats and packets, but also how to thwart the postal services cancelling methods, and/or cleaning methods for obliterating the cancellation dye marks from stamps. As used hereinafter, the term cancellation mark will mean any mark made for the purpose of cancellation postage, prepaid or otherwise, and may comprise a design, pattern, date, or other information. What is needed is a system for cancelling stamps that cannot be reversed. Furthermore, the system for cancelling stamps should be adaptable for manually cancelling stamps. Finally, the system should be adaptable for use with cancelling systems that are currently being used worldwide. As used hereinafter, the term “cancellation mark” will mean any mark made for the purpose of cancelling postage, prepaid or otherwise, and may comprise a design, pattern, date, or other information.

Therefore, in accordance with one exemplary embodiment of the present invention, a thermally cancellable stamp and system for use is presented below. Direct thermal imaging technology uses a document media which contains the “ink” in a colorless form as a coating on the surface of the paper or impregnated within its fibers. Heat generated in print head element is transferred to the thermal paper and activates the ink to develop color. Direct thermal imaging techniques use only a single consumable, the paper. Thermal paper is well known and has been in continuous use since the 1970's, but has not been used as a means for cancelling picture postage stamps. Thermal paper changes color when its heat reactive dye is exposed to heat over a trigger heat level, for instance over 125° F. (52° C.). Typically, these thermally reactive chemicals cause the substrate thermal paper to change to a black color from the white background. In some applications, the substrate paper may be treated with two or more chemicals that have different trigger levels and produce different colors when heated, such as black and violet or red.

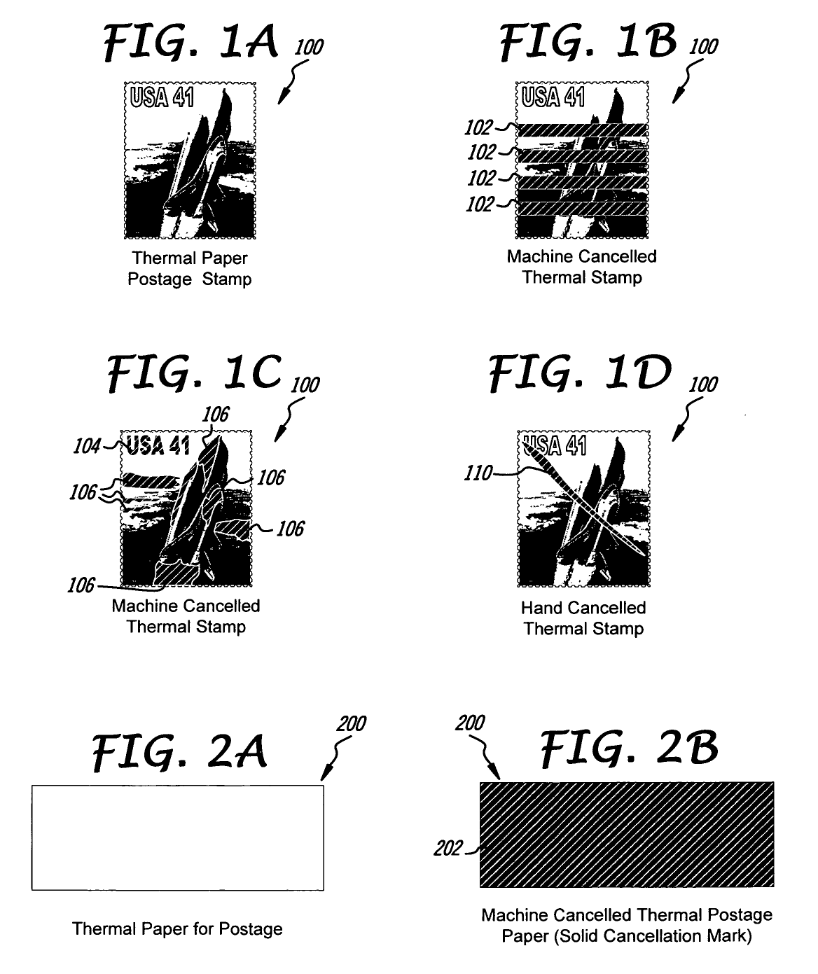

FIG. 1A is an illustration for a thermally cancellable stamp having indicia and postage in accordance with one exemplary embodiment of the present invention. Here, thermal stamp 100 generally comprises a thermal paper substrate which is at least partially covered with an indicia such as pictorial artwork or a design (the space shuttle and boosters in flight) and a face value (forty one cents). The substrate thermal paper (depicted as thermal paper 200 in FIG. 2A) may be any commercially available thermal paper, preferably with a gummed back for adhering to envelopes and the like. In accordance with one exemplary embodiment of the present invention, the entire paper substrate reacts to the trigger temperature (see machine cancelled thermal paper 200 in FIG. 2B). It should be mentioned that many postal services follow strict guidelines to the amount of heat that envelopes, flats, packets, mailers and packages may be subjected to, for instance 160° F. (71° C.). Therefore, the trigger temperature should be below that threshold, but above the level that stamps may be exposed to in their lifetime, for instance above the 110° F.-120° F. temperatures that may be generated in a closed automobile.

While cancelling the entire face of a thermally cancellable stamp is an option, typically postal services work in two modes: the collecting station and the delivery station. Both stations should be able to recognize the stamp as valid postage, even the delivery station which receives the cancelled stamp. Therefore, rather than thermally cancelling the thermally cancellable picture postage stamp, only a portion of the stamp is machine cancelled.

FIG. 1B is a diagram illustrating a thermally cancellable stamp after a partial thermal cancellation of the face of the stamp in accordance with one exemplary embodiment of the present invention. Here, thermally cancellable stamp 100 is subjected to a series of parallel thermal cancellation elements that result in the cancellation lines 102 across the face of the stamp. In accordance with one exemplary embodiment of the present invention, the thermal cancellation elements are spaced from each other and according to an alternative embodiment, thermally cancellable stamp 100 is chemically treated along lines 102, resulting in the parallel line cancellation pattern from exposure to a single thermal cancellation element. In accordance with still another exemplary embodiment of the present invention, the inks used for creating the artwork picture may themselves be thermally reactive used in combination with or separate from a thermal paper stamp substrate.

Alternatively, an opaque ink on the face of the stamp may partially obscure the thermal paper substrate. In that case, only certain portions of the stamp that are not obscured by ink can be seen as reacting to the thermal cancellation machine. FIG. 1C shows cancelled picture postage stamp in which the thermal paper is partially obscured by an opaque ink on the face of a thermally cancellable stamp in accordance with another exemplary embodiment of the present invention. Notice here, thermally cancellable stamp 100 has been thermally cancelled, however, the cancellation pattern is subject to the ink design of the artwork picture. Cancellation of this stamp is apparent because certain white spaces react to the thermal cancellation by changing colors, the remainder of the stamp is unchanged. Use of white (non-colored) backgrounds on the stamps for cancellation make it clearly visible when thermally cancellable stamps are cancelled, again for preventing reuse. For instance, face value 104 has darkened as have clouds 106 and vapor trail 108 in the image of the space shuttle and boosters in flight. As mentioned immediately above, this result may be achieved through the use of thermally reactive inks or dyes as well as the use of a thermal paper stamp substrate.

The use of thermally cancellable picture postage stamps in accordance with the present invention has another, heretofore unknown advantage, the present thermally cancellable picture postage stamps can also be cancelled manually, without the use of ink pens or markers. As mentioned elsewhere above, a significant amount of mail must be hand cancelled manually. These pieces are usually left in bins for someone to pen cancel the postage and return them to the automated sorting process. Many of these pieces were culled from the automated process simply because it was inconvenient for the culler to pen cancel letters, i.e., the worker did not have a “round stamp” or a pen available for pen cancelling the pieces. Use of the present invention will significantly reduce the amount of mail that is culled for pen cancellation because the worker culling the letters does not need any special instrument for cancelling the stamps, and in fact the present thermally cancellable stamp can be manually cancelled with a hard object, such as a fingernail, ring, or even pen point or a pen cap if the workers pen fails to mark.

FIG. 1 D shows a thermally cancellable stamp after manual cancelling in accordance with one exemplary embodiment of the present invention. Here, thermally cancellable stamp 100 has manual cancellation mark 108 across its face in an apparent random pattern. Other cancellation patterns may be adopted in accordance with the local postal station procedures, such as an “X” or a predetermined number of parallel lines, but in any case, the cancellation marks result from manually applying pressure to thermally cancellable stamp 100 and not from ink, dyes or heat. On advantage of the present invention is that by using thermally cancellable stamp 100 is that the stamp may be canceled anywhere in the mailing process. Typically, cancellation occurs by the cancellation department of either of the collection station or the delivery postage station. If some other postal worker mail with un-cancelled stamps, that worker usually will not take the time that is necessary to pen cancel the stamps. However, with the thermally cancellable stamp 100 anyone, or any postal worker can manually cancel a stamp, up to the delivery carrier, by applying pressure directly on the stamp by, using for instance, a fingernail, without the need to pull out a pen or an inked rubber cancelation stamp.

Thermal printer heads are generally faster and more reliable than the current method of cancelling using a mechanical ink and pad stamp for the placement of a cancellation mark at a precise location on each envelope. The current mechanical cancellation systems must be constantly monitored to ensure that the ink stamp is functional. Eventually, the cancellation mark will become blurred or otherwise deformed, necessitating the replacement of the ink stamp. Since the present invention utilizes a thermal cancellation head that need not actually make contact with the thermally cancellable picture postage stamp, the frequency of maintenance procedures may be significantly reduced. Furthermore, since the cancellation mark is controlled electronically, the design, information and commercial impression of the cancellation mark itself may be changed or altered and the cancellation date reset while the machine is in use.

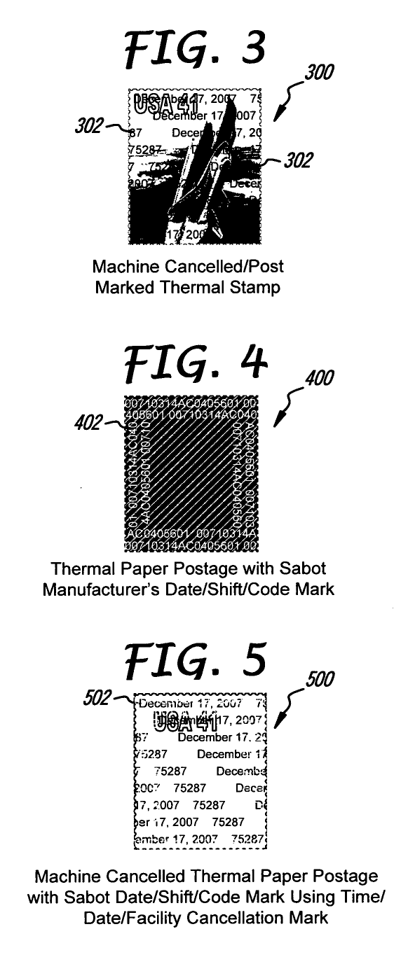

FIG. 3 is a diagram of a thermally cancellable stamp after thermal cancelling and postmarking in accordance with another exemplary embodiment of the present invention. Notice that thermally cancellable stamp 300 has been machine cancelled using postmark 302 consisting of the cancellation date and the postal code for the collecting postal station “75287 Dec. 17, 2007.” The presently described thermally cancellable stamp enables postal services to change, alter or update the cancellation mark in real-time and on the fly, remotely from the cancellation machine, electronically.

In accordance with still another exemplary embodiment of the present invention, postal services can embed secret text and code on the thermal paper substrate of the stamp (or in the thermally reactive ink of the stamp), that cannot be seen or recognized by the user unless the stamp is cancelled. Recent events have demonstrated how important postal information may be in a criminal or homeland security investigation. Not only are the identities of collecting and delivery postal centers important in these types of investigations, but also when and where the postage was purchased may be useful. This sabot information can be embedded onto a thermally cancellable stamp without the knowledge of the user, for example, the date-shift-code of the stamp's manufacturer. Date-shift-codes have long been used by the Bureau of Alcohol, Tobacco and Firearms (ATF) of the Justice Department for tracking the manufacturer of the explosives along with the date and shift that explosives and/or gun powder was manufactured. This gives investigators some clues as to the origination and sale point of explosive materials. FIG. 4 shows thermal paper stamp stock with a sabot origination code in accordance with one exemplary embodiment of the present invention. Here, thermal paper stamp stock 400 is treated with thermally reactive chemicals in the presence of a mask or other device for date-shift-code 402 of “00710314AC0405601.” Although the present example demonstrates the use of date-shift-code information, other secret information may be embodied on thermal paper stamp stock 400, such as cryptographically generated numbers of keys that can be decrypted for manufacturer, sales, region or other information.

FIG. 5 shows thermally cancellable picture postage stamp with embedded sabot information after thermal cancellation and postmarking in accordance with an exemplary embodiment of the present invention. Here, thermal paper picture postage stamp 500 includes sabot information that is not recognizable by the human eye or without exposure to heat. Notice that stamp 500 is once again machine cancelled using postmark 502 consisting of the cancellation date and the postal code for the collecting postal station “75287 Dec. 17, 2007.” However, in this case the sabot information can be detected through cancellation mark 502, however the sabot information may not be understandable. If, at some point, a letter with an embedded sabot code becomes the subject of an investigation, the investigators have a ready source of information from the sabot information by merely exposing the sabot area to heat (the remainder of the stamp will remain pristine).

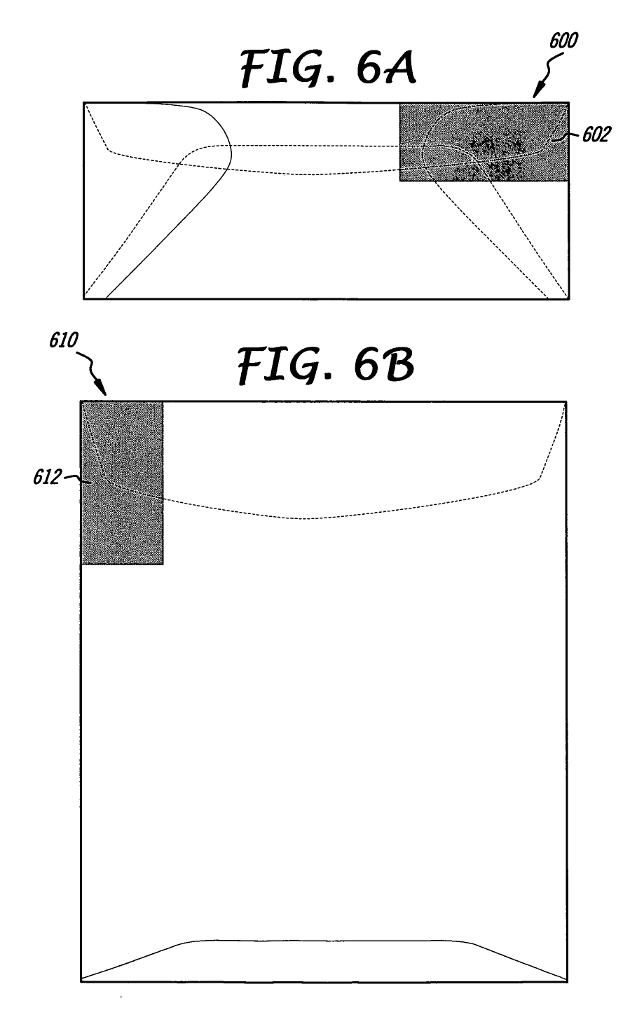

In accordance with still another exemplary embodiment of the present invention, a predetermined area of envelopes, flats and other types of mailers may be treated with a thermally receptive chemical for receiving postage and/or cancellation marks. FIG. 6A shows a typical number 10 envelope (business letter) with a thermally receptive treatment in the area for receiving postage in accordance with one exemplary embodiment of the present invention. Here, envelope 600 has thermally receptive area 602 (approximately 2 inches by 4 inches) treated with a thermally reactive chemical. Treatment area 602 is much larger than is necessary for a typical placement of multiple stamps, therefore, treatment area 602 will react to the cancellation in the same manner as a thermally cancellable picture postage stamp. FIG. 6B shows typical business class mailer 610 with a thermally receptive treatment in area 612 for receiving postage in accordance with another exemplary embodiment of the present invention. Envelopes with a thermally receptive treatment in the area for receiving postage have another advantage for businesses in that the postage can be thermographically written onto the mailer in area 612, thereby eliminating the necessity for postal inks and the like.

One advantage of using the presently described thermally cancellable picture postage stamps is that the stamps may be thermally cancelled by a process that does not mark areas without thermally reactive chemicals. Therefore, the envelope need not be reoriented to the proper orientation prior to cancelling the stamp as is performed by the AFCS/ISS currently used by the U.S. Postal Service. Furthermore, because the cancellation is performed electronically, the same cancellation device can be used for cancelling mailers regardless of their size (unlike the current AFCS/ISS which requires the mail be sorted by size prior to cancellation).

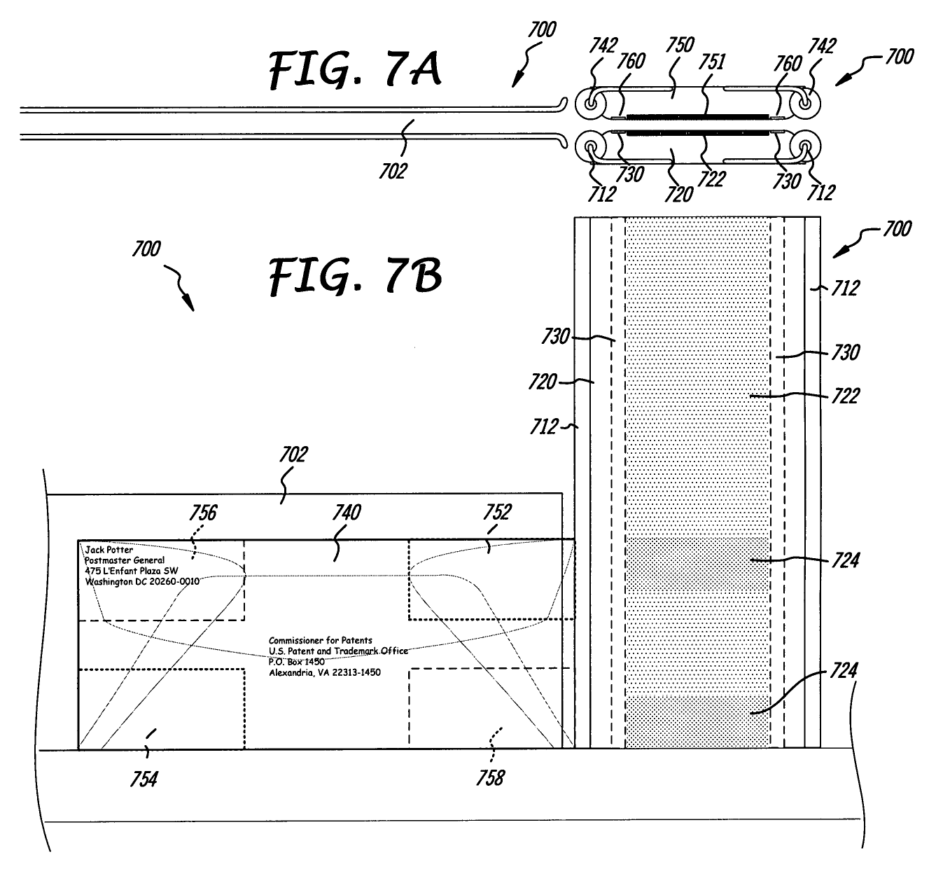

FIGS. 7A and 7B are top and side views of a thermal cancellation writer in accordance with one exemplary embodiment of the present invention. Envelopes 740 and the like are moved along track 702 between a pair of rails to thermal cancellation writer 700. Essentially, thermal cancellation writer 700 comprises two opposing thermal write heads 720 and 750 that perform simultaneously as a thermal write head and platen for the opposing thermal write head. Each of thermal write heads 720 and 750 have one or more linear strips of heating resistors 722 and 751 or the like for generating heat for activating the thermally reactive chemical on the stamp (the figures show multiple linear rows of heating resistors that are arranged in multiple columns having the approximate width of the cancellation area, thereby enabling the entire area to be cancelled simultaneously. Mail is moved across heating resistors 722 and 751 of thermal write heads 720 and 750 by a pair of powered rollers 712 and 742 which engage each piece of mail and move it at a predetermined speed.

Additionally, thermal write heads 720 and 750 have optical sensors 730 and 760 for detecting front and rear edges, and sensing the height on an envelope. By detecting the height of envelope 740, only heating resistors 722 and 751, which are adjacent to a possible location of a stamp on envelope 740, are allowed to activate, and then only when optical sensors 730 and 760 detect an edge of envelope 740 indicating that a cancellation area (one of areas 752, 754, 756 and 758) is proximate to a thermal write head. Optically, thermal cancellation writer 700 may further comprise several heated rollers (not shown) with a cancelation mark embossed thereon, for cancelling stamps. These rollers would serve the same purpose as thermal write heads 720 and 750, but roll along the upper and lower edges of envelope 740 at fixed positions and apply heat for cancelling any stamps thereon (as a practically matter a total of four heated rollers may be necessary for cancellation stamps at upper front. lower front, upper rear and lower rear positions on an envelope).

For example, envelope 740 travels along track 702 until its leading edge is detected by forward optical sensors 730 and 760. The height is determined from the sensors and the possible locations of a stamp on the forward portion of envelope 740. If the stamp is on the forward portion of envelope 740 (to the right on FIG. 7B), it will be located on the forward facing upper corner 752 or the rear facing lower corner 758. Thermal cancellation writer 700 does not need to know if a stamp is located on either of forward facing upper corner 752 or the rear facing lower corner 758, because heating elements in band 724 are activated when its leading edge is detected by rear optical sensors 730 and 760. Then, a thermal cancellation mark is applied to both forward facing upper corner 752 and the rear facing lower corner 758. If a thermally cancellable stamp is located in either area 752 or 758, it will be thermally cancelled. If not, the heat will not affect the address label (even if it is a thermal label) because thermal cancellation writer 700 heats only areas 752 and 758 of envelope 740 and not the address portion of the envelope.

A stamp may be located on the rear portion of envelope 740 (to the left on FIG. 7B), it will be located on the forward facing lower corner 754 or the rear facing upper corner 756. As envelope 740 continues moving forward, its trailing edge is detected by forward optical sensors 730 and 760 and heating elements in bands 724 are activated, thereby applying a thermal cancellation mark to both forward facing lower corner 754 and the rear facing upper corner 756.

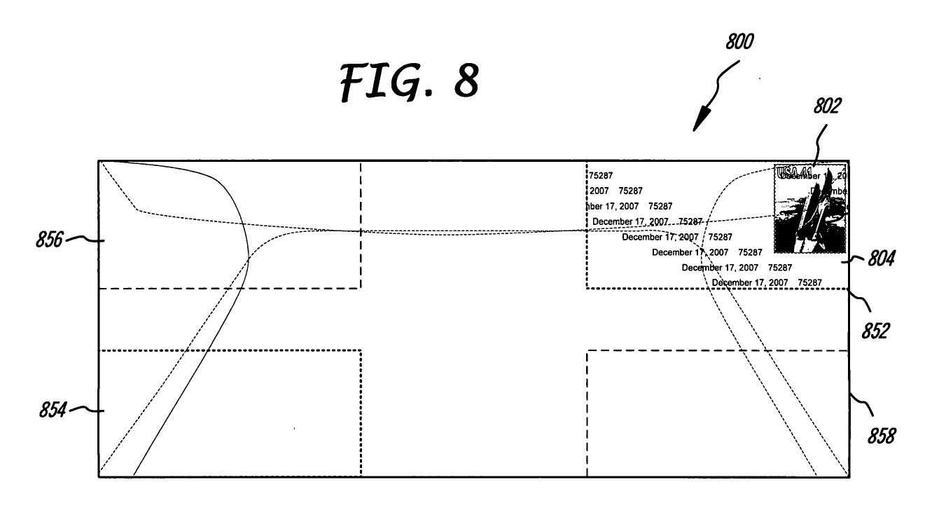

FIG. 8 shows a thermally receptive number 10 envelope posted with a thermally cancellable stamp after being cancelled with the present thermal cancellation writer in accordance with an exemplary embodiment of the present invention. Notice that thermal cancellation mark 804 traverses thermally cancellable stamp 802 and extends across thermally receptive cancellation area 806, thereby providing further verification that thermally cancellable stamp 802 is not being reused.

Another means for ensuring that stamps are not reused and relieving the postal service from the task of cancelling every stamp that is received is by self cancelling stamps prior to mailing. The practice of self-cancellation is well known and accepted by the U.S. Postal Service to anyone with a Mailer's Postmark Permit (MPP). With the MPP, a cancellation is applied to the stamp by a mailer before depositing it with the postal service. The present invention provides the means for expanding self-cancellation practices to virtually anyone without increasing stamp reuse.

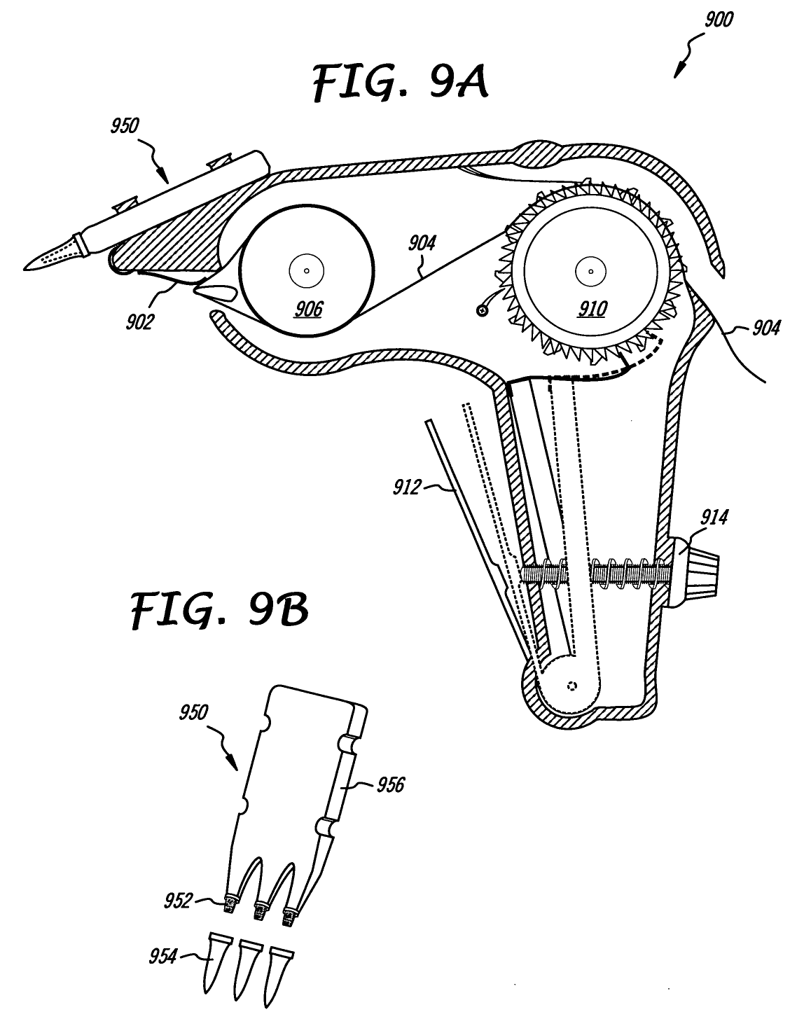

FIG. 9A is a cross-sectional diagram of a manual self-cancelling postage stamp ‘gun’ for simultaneously posting and cancelling a picture postage stamp in accordance with an exemplary embodiment of the present invention. The purpose of manual self-cancelling postage stamp gun 900 is to simultaneously affix a picture postal stamp and cancelling the stamp in such a way that reuse would easily be detected. A roll of thermally cancellable picture postage stamps 906 is received on a spindle within gun 900. Each roll may contain between 100 (personal use) and 500 (business use) stamps with strong adhesive backing, further preventing re-users from peeling the stamps off and reusing them, such pressure adhesive 3M™ Adhesive Transfer Tape by Adhesive Type from the 3M company of St. Paul, Minn. Each of thermally cancellable picture postage stamps 902 are temporarily fastened to a roll of perforated backing paper 904. Perforated backing paper 904 is fed across drive gear 910 that is actuated by advance lever 912. Each time advance lever 912 is released, one thermally cancellable stamp 902 is pealed off of perforated backing paper 904 proximate to cancellation marker 950. Optionally, advance lever 912 may be coupled top level strode adjustment 914 for adjusting the stroke of advance lever 912 to accommodate stamps of different lengths on perforated backing paper 904.

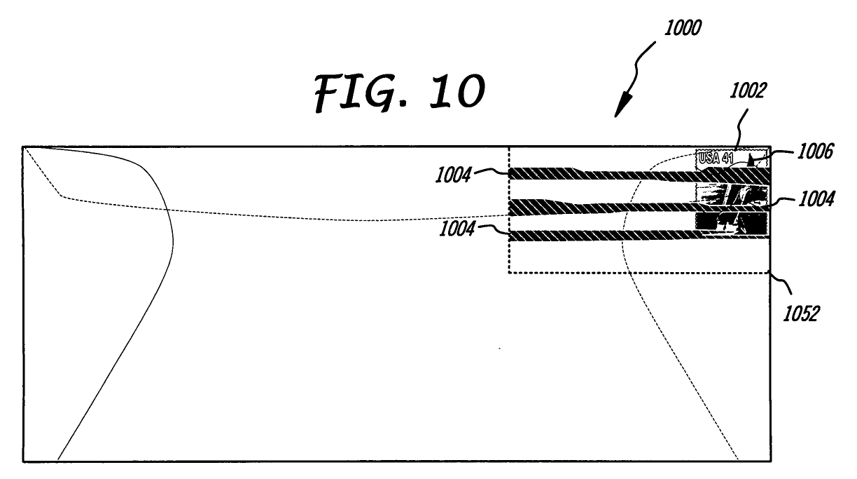

In practice, a user merely positions marker points 952 or marker covers/cancellation tips 954 on an envelope slightly to the left of where the stamp should be positioned on the envelope, and as advance lever 912 is released, dragging the gun to the right, thereby applying postages and simultaneously cancelling same. FIG. 9B is a diagram of cancellation marker 950 for cancelling a thermally cancellable stamp in accordance with an exemplary embodiment of the present invention. Recall that one benefit of the present thermally cancellable stamp is that the stamp can be cancelled by pressure and heat as well as by pen cancelling as is known in the prior art. Therefore, cancellation marker 950 comprises position marker points 952 for pen marking, but also marker covers/cancellation tips 954 for manually cancelling thermally cancellable picture postage stamps without heat or ink marking. FIG. 10 shows a thermally receptive envelope posted with a thermally cancellable stamp after being manually cancelled with the present self-cancelling postage stamp gun in accordance with an exemplary embodiment of the present invention. Here, envelope 1000 thermally receptive cancellation area 1052, in which thermally cancellable stamp 1002 has been affixed using self-cancelling postage stamp gun 900. Notice that cancellation marks 1004 from position marker points 952 or marker covers/cancellation tips 954 traverse the width of stamp 1002 thereby providing further verifying to the postal authority that stamp 1002 has not been reused. Because thermally cancellable picture postage stamps 902 are provided on roll 906 for applications using gun 900, the stamps can be sectioned on backing paper 904 at score lines 1006. In so doing, thermally cancellable picture postage stamp 902 is easily applied to an envelope without tearing. If removed, thermally cancellable picture postage stamp 902 will split into two, three or more voided sections of the stamp. Thus, the use of manual self-cancelling postage stamp gun 900 further reduces the opportunity for stamp reuse because attempting to remove a stamp from an envelope will part it at score lines 1006.

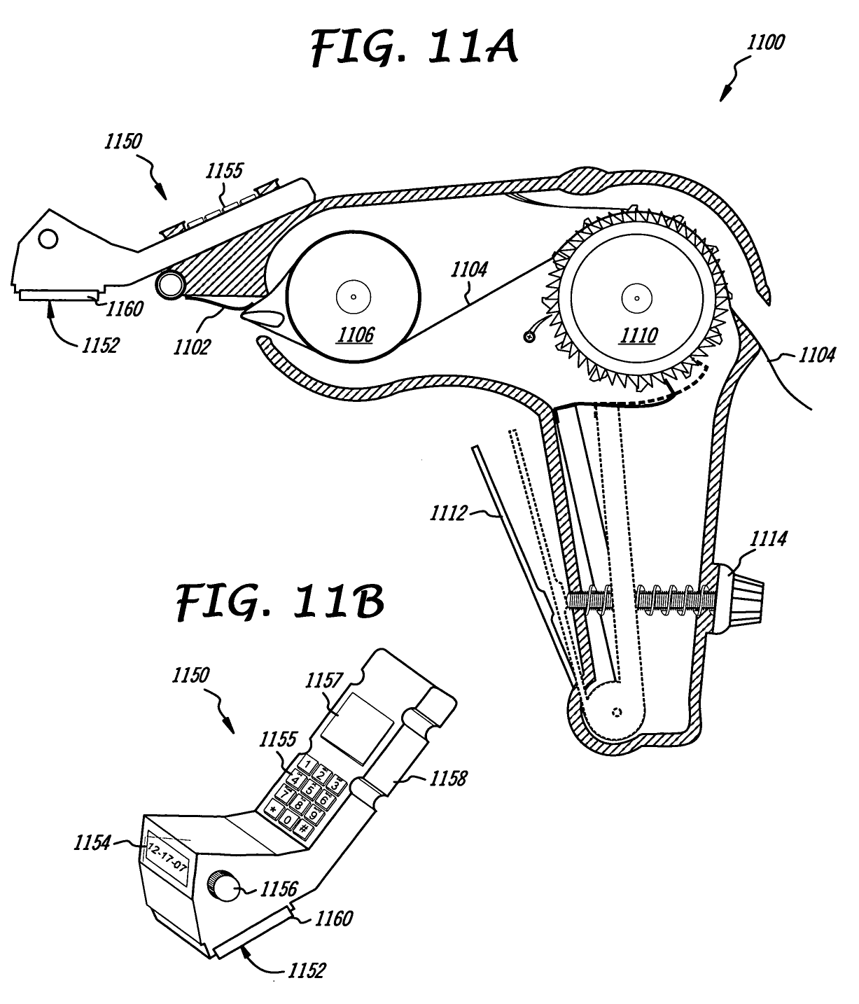

It is also possible to modify manual self-cancelling postage stamp gun 900 with a thermal cancellation write head for performing thermal cancellations. FIG. 11A is a cross-sectional diagram of a thermal self-cancelling postage stamp gun for simultaneously posting and cancelling a picture postage stamp in accordance with an exemplary embodiment of the present invention. This device is similar to manual self-cancelling postage stamp gun 900 discussed above with regard to FIGS. 9A and 9B, with the exception of the inclusion of a thermal cancellation write head.

FIG. 11B is a diagram of thermal cancellation write head 1150 for cancelling a thermally cancellable stamp in accordance with an exemplary embodiment of the present invention. Thermal cancellation write head 1150 generally comprises downward facing thermal write elements 1152 that are arranged in a two-dimensional matrix. Individual thermal write elements can be selected and enabled for activation to form pattern designs, words or more probably the current date (using date adjustment/advance knob 1156 and/or keypad 1155 with screen 1157) and the correct date verified on preview window 1154. Activation of the enabled thermal write elements 1152 is accomplished via actuator switch 1160 which senses the position of the envelope to thermal cancellation write head 1150, and activates the heating elements for self-cancelling a thermally cancellable picture postage stamp.

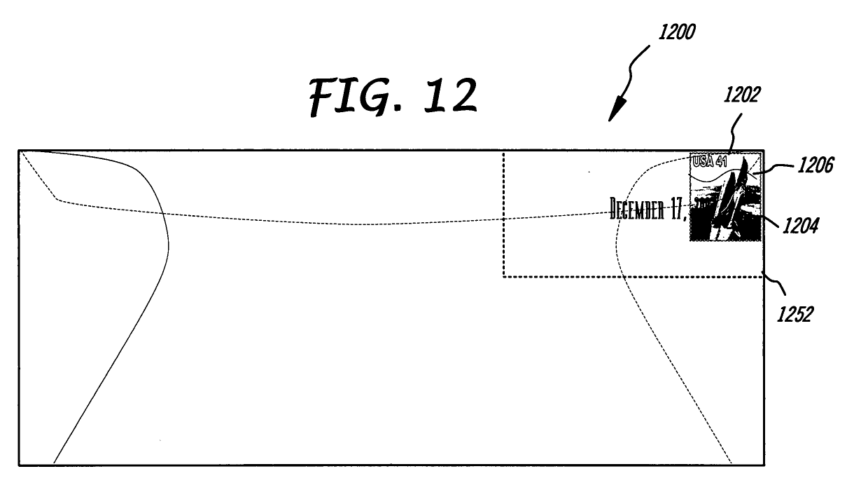

FIG. 12 shows a thermally receptive envelope posted with a thermally cancellable stamp after being thermally cancelled with the present thermal self-cancelling postage stamp gun in accordance with an exemplary embodiment of the present invention. Here again, envelope 1200 has thermally receptive cancellation area 1252, in which thermally cancellable stamp 1202 has been affixed using thermal self-cancelling postage stamp gun 1100. Notice here that cancellation mark 1204 is the mail deposit current date of “Dec. 17, 2007,” and that cancellation mark 1204 traverses from position marker points 952 or marker covers/cancellation tips 954 traverses thermally cancellable stamp 1202 and across thermally receptive cancellation area 1252 of envelope 1200. Score lines 1206 may also be provided to prevent pealing a used stamp from a mailer.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A system for cancelling postage comprising:
a thermally cancellable postage stamp comprising:
a paper substrate having a first surface and a second surface;
an indicia affixed to at least a portion of the first surface of the paper substrate; and
a face amount indicator affixed to at least a portion of the first surface of the paper substrate; wherein one of the paper substrate, indicia and face amount indicator is thermal sensitive.

2. The system recited in claim 1, wherein at least a portion of the paper substrate is thermal sensitive for receiving a thermal cancellation mark.

3. The system recited in claim 2, wherein at least a portion of the paper substrate is pressure sensitive for receiving a pressure induced cancellation mark.

4. The system recited in claim 3, wherein the at least a portion of the paper substrate has a trigger heat level of at least one hundred and twenty degrees Fahrenheit.

5. The system recited in claim 3, wherein the indicia is opaque and covers less than 95% of the first surface of the paper substrate.

6. The system recited in claim 3, wherein the face amount indicator covers less than 95% of the first surface of the paper substrate.

7. The system recited in claim 3, further comprises:
a thermal cancellation device, said thermal cancellation device having a heating element capable of generating a heat level above a trigger heat level of the paper substrate for creating a thermal cancellation mark on the thermally cancellable postage stamp.

8. The system recited in claim 3, further comprises:
a manual cancellation device, said manual cancellation device having force applicator for applying pressure to the paper substrate for creating a pressure-induced cancellation mark on the thermally cancellable postage stamp.

9. The system recited in claim 7, further comprises:
a manual cancellation device, said manual cancellation device having force applicator for applying pressure to the paper substrate for creating a pressure-induced cancellation mark on the thermally cancellable postage stamp.

10. The system recited in claim 3, wherein the thermally cancellable postage stamp further comprises at least one score line.

11. The system recited in claim 3, wherein a plurality of thermally cancellable postage stamps are configured as a roll, the system further comprises:
a handheld cancellation device for simultaneously metering off and cancelling one of the plurality of thermally cancellable postage stamps.

12. The system recited in claim 11, wherein the handheld cancellation device further comprises:
a mechanical cancellation component for applying pressure to the one of the plurality of thermally cancellable postage stamps.

13. The system recited in claim 11, wherein the handheld cancellation device further comprises:
a thermal cancellation component for applying thermal energy to the one of the plurality of thermally cancellable postage stamps.

14. The system recited in claim 13, wherein the thermal cancellation component produces date information as at least a portion of a cancellation mark.

15. The system recited in claim 3, further comprises:
a mailer, comprising:
an interior compartment for enclosing items;
at least one exterior surface; and
a thermal sensitive area on the at least one exterior surface proximate to a location for placement of said thermally cancellable postage stamp.

16. The system recited in claim 15, further comprises:
a thermal cancellation device, said thermal cancellation device having a heating element capable of generating a heat level above a trigger heat level of the paper substrate for creating a thermal cancellation mark on the thermally cancellable postage stamp and the thermal sensitive area on the at least one exterior surface of the mailer.

17. The system recited in claim 3, wherein the at least a portion of the thermal sensitive paper substrate is treated with at least one thermal sensitive dye.

18. The system recited in claim 3, wherein the at least a portion of the thermal sensitive paper substrate is treated with at least two thermal sensitive dyes, the first thermal sensitive dye having a first trigger heat level the second thermal sensitive dye having a second trigger heat level.

19. The system recited in claim 3, wherein the at least a portion of the thermal sensitive paper substrate contains hidden information.

20. The system recited in claim 15, wherein the thermal cancellation device further comprises:
a user interface for altering a cancelation mark.
